(19) United States
(12) Patent Application Publication
(10) Pub. No.: US 2020/0332094 A1
(43) Pub. Date: Oct. 22, 2020

(54) WARPAGE FREE 3D PRINTING OF POLYMERS

(71) Applicant: Council of Scientific & Industrial Research, New Delhi (IN)

(72) Inventors: Guruswamy Kumaraswamy, Pune (IN); Aniket Avinash Gudadhe, Pune (IN)

(21) Appl. No.: 16/763,196

(22) PCT Filed: Nov. 13, 2018
(86) PCT No.: PCT/IN2018/050740

§ 371 Date: May 11, 2020

(30) Foreign Application Priority Data
Nov. 13, 2017 (IN) 201711040358

(51) Int. Cl. C08L 23/06; C08K 5/1575; C08L 23/12; C08L 23/14; C08L 71/02; B29C 64/118; B33Y 70/00; B33Y 80/00

(52) U.S. Cl. CPC C08L 23/06; C08K 5/1575; C08L 23/12; C08L 23/14; C08L 71/02; B82Y 30/00; B33Y 70/00; B33Y 80/00; C08L 2207/062; C08L 2207/066; C08L 2207/10; B29C 64/118

(57) ABSTRACT

A composition contains a blend of a primary polymer and a secondary polymer, an additive and an adhesive. The secondary polymer is less crystalline than the primary polymer, and the additive increases the melt viscosity of the blend. The composition can be used in 3D printing to result in reduced warping of polymers during 3D printing, especially when using lower polymers, such as, HDPE and LLDPE.

### FIELD OF THE INVENTION

The present invention relates to polymer based three-dimensional (3D) printing. Particularly present invention relates to a polymer composition for preventing warpage during 3D printing process and method of preparation of the same.

### BACKGROUND & PRIOR ART OF THE INVENTION

For 3D printing of polymer object, it is a general practice to melt and arrange polymer strands layer by layer to obtain a 3D printed polymer object. This method is called Fused Deposition Modelling (FDM). In FDM printing, the polymers which are commonly used are Acrylonitrile butadiene styrene (ABS), polylactic acid (PLA). These polymers are cooled from the melt into the solid state during FDM printing. FDM printing of semicrystalline polymers has been challenging due to the shrinkage of the polymers on cooling, resulting into stress and, consequently, warpage of the printed end product. Semicrystalline polyolefins such as polyethylene and polypropylene represent the most widely produced synthetic polymers.

Further, it may be stated that, both polyethylene (PE) and polypropylene (PP) are extensively used for manufacturing numerous articles which are used both in commercial field as well as at homes. As result of which both said polymers are produced on very large scale. However, the polymers pose one glaring issue of recyclability. Both the polymers are highly stable and are not degradable. As result of which they tend to accumulate in the environment causing pollution. Hence, to decrease the load on environment, one option of recycling is the use of PE and PP in more lasting manner in form of 3D/FDM printed articles. However, they are not amenable to FDM printing and warp excessively on cooling. For the stated reasons, polyethylene and isotactic polypropylene (including those sourced from the waste/recycle stream) are not considered FDM printable.

There have been attempts to overcome the warpage of polymers, such as disclosed in U.S. Pat. No. 9,592,660. Another document US20160177078 provides a material to obtain a warpage-free fused deposition modelling type 3D modelling. The invention claimed US'078 claims a material obtained by blending 10 to 900 parts by weight of a styrene-based resin (B1) obtained by copolymerizing an aromatic vinyl-based monomer (b1) and a vinyl cyanide-based monomer (b2), and/or 5 to 400 parts by weight of a thermoplastic resin (B2) the glass transition temperature of which is 20° C., or lower, and/or 5 to 30 parts by weight of a plasticizer (B3) relative to 100 parts by weight of a polylactic acid resin (A). However, these materials in their 3D printed form either do not crystallize on cooling or crystallize very slowly relative to polyolefins such as polyethylene or isotactic polypropylene. Therefore, the associated volume shrinkage is low and it is possible to 3D print these without significant warpage.

The present invention provides a simple approach by which the warping of the semicrystalline polymers may be avoided completely during 3D printing.

### OBJECT OF THE INVENTION

Main object of the present invention is to provide polymer based three-dimensional (3D) printing.

Another object of the present invention is to prevent warping of the polymer during 3D printing process by Fused Deposition Modelling (FDM) technique.

Yet another object of the present invention is to produce a composition of the polymer strands to overcome the warping of the polymer during 3D printing process by Fused Deposition Modelling (FDM) technique.

### SUMMARY OF THE INVENTION

Accordingly, present invention provides a composition for warpage free 3D printing comprising a blend of
i. 98 to 99.8 parts of a semi-crystalline polymer and;
ii. 0.2 to 2 parts of a nanofibrillar network forming additive.

In an embodiment of the present invention, the additive used is a sorbitol derivative which dissolves into the polymer above the melt temperature of the said polymer to form a nanofibrillar network.

In another embodiment of the present invention, sorbitol derivative is selected from dimethyldibenzylidene sorbitol (DMDBS) or 1,2,3-tridesoxy-4,6:5,7-bis-O-[(4-propylphenyl)methylene]nonitol sorbitol (NX 8000).

In yet another embodiment of the present invention, semi-crystalline polymer(s) is selected from the group consisting of High-Density Polyethylene (HDPE), Medium-Density Polyethylene (MDPE), low density polyethylene (LDPE), linear low density polyethylene (LLDPE), Polyoxymethylene (POM), isotactic Polypropylene (PP), copolymer of Polypropylene (CP-PP), impact copolymer of polypropylene (IC-PP) either alone or combination thereof.

In yet another embodiment, present invention provides a process for warpage free 3D printing comprising the steps of:
a) preparing a blend of 98-99.8 parts of a semi-crystalline polymer and 0.2-2 parts of a nanofibrillar network forming additive;
b) compounding the blend as obtained in step (a) above the melting temperature of the semicrystalline polymer to obtain a uniform composition;
c) extruding the composition as obtained in step (b) to obtain a constant diameter filament;
d) using the filament as obtained in step (c) for warpage free 3d printing.

In yet another embodiment, present invention provides a system for warpage free 3D printing comprising a blend of 98 to 99.8 parts of semi-crystalline polymer and 0.2-2.0 parts of a nanofibrillar network forming additive.

In yet another embodiment of the present invention, semi-crystalline polymer used is combination of 5-15 parts of LLDPE in High-Density Polyethylene (HDPE).

In yet another embodiment of the present invention, semi-crystalline polymer used is selected from the group consisting of Medium-Density Polyethylene (MDPE), low density polyethylene (LDPE), linear low density polyethylene (LLDPE), Polyoxymethylene (POM), isotactic Polypropylene (PP), copolymer of Polypropylene (CP-PP), impact copolymer of polypropylene (IC-PP) either alone or combination thereof.

In yet another embodiment of the present invention, the additive used is a sorbitol derivative, said sorbitol derivative dissolves into said polymer above melt temperature of said polymer to form a nanofibrillar network.

In yet another embodiment of the present invention, said sorbitol derivative is selected from dimethyldibenzylidene sorbitol (DMDBS) or 1,2,3-tridesoxy-4,6:5,7-bis-O-[(4-propylphenyl)methylene]nonitol sorbitol (NX 8000).

In yet another embodiment, present invention provides use of the composition for warpage free 3d printing.

### BRIEF DESCRIPTION OF DRAWINGS

FIG. 1 represents the change in complex viscosity of the polymer composition comprising HDPE and 0.4%, 0.8% and 1.6% dimethyldibenzylidene sorbitol respectively is cooled from 240° C.

FIG. 2(a) and FIG. 2(b) represents the final 3D print of objects using a polymer composition comprising 89.6% HDPE, 0.4% dimethyldibenzylidene sorbitol and 10% LLDPE, as described in Example 1.

FIG. 3 represents the change in complex viscosity as a polymer composition comprising 89.2% HDPE, 0.8% Millad NX 8000 and 10% LLDPE is cooled from 200° C. to 120° C.

FIG. 4 represents the final 3D print of a bar using a polymer composition comprising 89.2% HDPE, 0.8% Millad NX 8000 sorbitol and 10% LLDPE, as described in Example 2.

### DETAILED DESCRIPTION OF THE INVENTION

The present invention discloses composition comprising a polymer with an additive that increases the melt viscosity of the polymer melt as it cools after it is extruded and before it can crystallize Further, in order to reduce the gap in modulus between melt and solid states of the polymer, the primary polymer is, optionally, blended with a secondary polymer. Furthermore, an adhesive is applied on a print substrate.

The polymer is a semicrystalline polyolefin selected from the group consisting of HDPE, LLDPE, Polypropylene (PP), Polyethylene (PE), and blends thereof.

Secondary polymer is less crystalline than the primary polymer.

The additive is selected from derivatives of sorbitol or nanofillers.

The nanofillers is selected from the group consisting of nanoclay, graphene, carbon nanotubes or any other such material.

The additive is preferably derivatives of sorbitol.

The additive is dimethyldibenzylidene sorbitol.

In one of the aspect, the polymer composition may be in the form of filament.

The polymer composition comprises a primary polymer present in an amount of 98-99.8%, and an additive present in an amount of 0.2-2%.

Present invention discloses a polymer composition that prevents warping in a 3D object printed by FDM technique, comprises a polymer and an additive that increases the melt viscosity of the polymer melt before crystallization.

The polymer composition comprises of a polymer and an additive, such that the additive is capable of forming a nanofibrillar network.

The polymer could be a single polymer or a combination of polymers. Said one or more polymer(s) could be selected from High-Density Polyethylene (HDPE), Medium-Density Polyethylene (MDPE), low density polyethylene (LDPE), linear low density polyethylene (LLDPE), Polyoxymethylene (POM), isotactic Polypropylene (PP), copolymer of Polypropylene (CP-PP) or impact copolymer of polypropylene (IC-PP).

The polymer could be a combination of a primary semi-crystalline polymer and a secondary semi-crystalline polymer such that, the secondary polymer has preferably less crystallinity than the primary polymer. For the purpose of this embodiment, the primary polymer forms majority component of the blend, constituting about 85-100 parts of the blend, while the secondary polymer constitutes a minority components of blend being present in range of 0-15 parts.

The primary semi-crystalline polymer is selected from High-Density Polyethylene (HDPE), Medium-Density Polyethylene (MDPE), or isotactic polypropylene and the secondary semi-crystalline polymer is selected from atactic polypropylene copolymer of Polypropylene (CP-PP) or Low density polyethylene (LDPE), Linear Low density polyethylene (LLDPE). Preferably the primary semi-crystalline polymer is High-Density Polyethylene (HDPE) and the secondary semi-crystalline polymer is Linear Low density polyethylene (LLDPE).

The additive of the composition of the present invention is selected from derivatives of sorbitol. Preferably, said sorbitol derivatives dissolve into the polymer melt at elevated temperature, typically above 190° C. and that precipitate to form a nanofibrillar network on cooling, at temperatures where the polymer is still molten. The nanofibrillar network formed by the additive increased the stiffness of the polymer thereby eliminating warping.

The additive is dimethyldibenzylidene sorbitol (DMDBS) which is a derivative of sorbitol. The said derivative of sorbitol increases the melt viscosity of the polymer melt before crystallization. This decreases the gap in modulus between the melt and solid states. The sorbitol derivative undergoes phase change from dissolved phase in polymer melt to a solid nanofibre network as the melt cools. This phase change of the additive helps in reducing warpage by increasing the modulus of the polymer melt.

Alternatively, the additive is 1,2,3-tridesoxy-4,6:5,7-bis-O-[(4-propylphenyl)methylene]nonitol sorbitol (NX 8000), marketed as Millad NX 8000 by Milliken & Company. The NX 8000 increases the complex viscosity at about 160° C., above the polyethylene crystallization temperature. This increase is attributed to the formation of a reinforcing network of the Millad NX 8000 in the polyethylene melt. This reduced warpage in the printed material.

The composition of the invention further comprises of an adhesive. The adhesive, preferably, is a resin based adhesive, sold under brand name “Fevistik®” by Pidilite Industries Ltd or any acrylic based adhesive. The adhesive maintains registry during the printing operation by adhering the printed part to the substrate and preventing it from moving.

The method of preparation of polymer composition of the invention comprises of:
i. Preparing a mixture of a primary polymer, an additive, and, optionally, a secondary polymer;
ii. Compounding in the DSM co-rotating twin screw microcompounder at a temperature above the polymer melting point, with screw speed of 100 rpm;
iii. Mixing the composition for certain time;
iv. Extruding the composition so as to obtain a constant diameter filament.

### EXAMPLES

Following examples are given by way of illustration and therefore should not be construed to limit the scope of the invention.

The example below demonstrates the effectiveness of the polymer composition of the instant invention, wherein the primary polymer is HDPE, the secondary polymer is LLDPE and the additive is Dimethyldibenzylidene sorbitol. For the purpose of demonstration, HDPE of the polymer composition may be obtained from waste plastic bottle, such as brand “Harpic” bottle and Dimethyldibenzylidene sorbitol may be obtained from product called “Millad 3988” by its tradename, manufactured by Milliken.

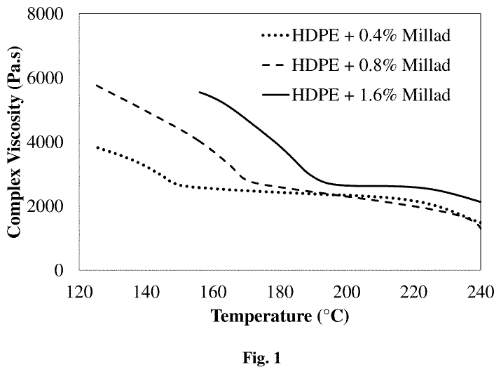

FIG. 1 illustrates the complex viscosity of HDPE containing 0.4%, 0.8% and 1.6% of dimethyldibenzylidene sorbitol (DMDBS), as a function of temperature. The viscosity does not increase at high temperature above that of the polyethylene melt, above 195° C., and increases only on cooling to lower temperatures.

### Example 1

The polymer composition comprising HDPE present in amount of 89.6%, dimethyldibenzylidene sorbitol in amount of 0.4% and LLDPE present in amount of 10% was prepared. HDPE of the instant composition has MFI of 1, and with a DSC melting point of approximately 140° C. The composition was compounded in the DSM co-rotating twin screw microcompounder at 190° C. with screw speed of 100 rpm. The composition is mixed for 5 min to allow for efficient mixing and extruded thereafter in the form of strands which are pelletized manually.

With extrusion of the pelletized material, a filament with diameter 1.70 (±0.05) mm is prepared at 190° C. through “Göttfert Capillary Rheometer” at a fixed speed which is optimised to provide a filament with a constant diameter of 1.75 mm (+/−0.05 mm). The filament obtained in the said manner is wound on a spool which may be connected to the 3D printer.

The filament is loaded in “Julia”, an FDM based 3D printer of Fractal Works, and printed with following print parameters:

1) Nozzle Diameter=0.4 mm

2) Nozzle Temperature=190° C.

3) Bed Temperature=60° C.

4) Bottom Layer Thickness=0.3 mm

5) Print Speed=45 mm/s

6) Fill Density=20%

7) Adhesion Assist: Thin layer of glue from a glue stick is applied on the bed for improved adhesion.

8) Adhesion Assist: Brim=15 Lines

9) Cooling Fan: Enabled at full after 0.5 mm

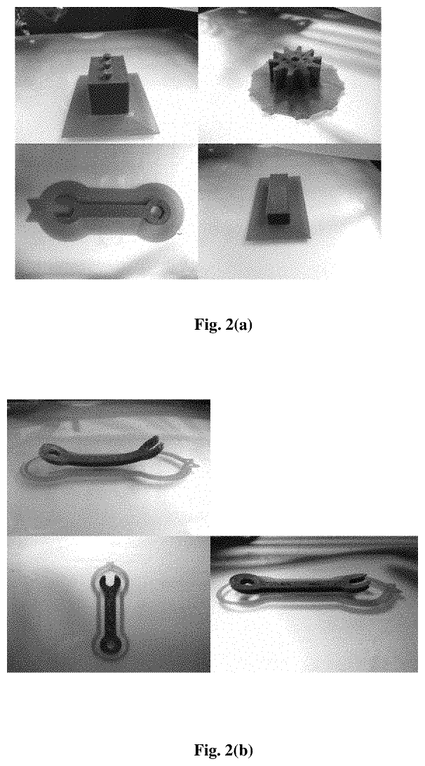

3D objects printed with the instant invention, demonstrated in FIG. 2(a) & FIG. 2(b), are warpage-free.

The warpage is calculated using following formula:

$$Warpage = 100 - \frac{Lay flat Height}{Thickness} \times 100$$

A higher value indicates higher warping. A long, solid bar, having dimensions of x=50 mm, y=15 mm, z=10 mm is selected as the standard test part for the calculations of warpings. In the case of our test part (the long solid bar, that is most prone to warpage), the features which warp the most are the corners of the bar. Therefore, warping is calculated at the corner and that value is assigned to the part.

Warpage of standard test part printed with different compositions:

| | Neat | 0.4% (DMDBS) + | 0.4% (DMDBS) + 10% |
|---|---|---|---|
| | HDPE | 99.6% HDPE | LLDPE + 89.6% HDPE |
| Warpage | 9 | 6.3 | 0 |
| Parameter | | | |

### Example 2

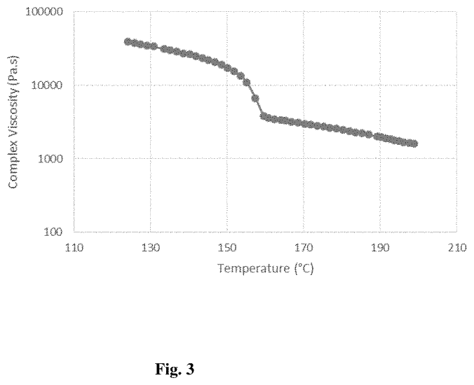

A polymer composition comprising HDPE present in amount of 89.2%, commercial sorbitol derivative Millad NX 8000 in amount of 0.8% and LLDPE present in amount of 10% was prepared. HDPE of the instant composition has MFI of 1, and with a DSC melting point of approximately 140° C. The composition was compounded in the DSM co-rotating twin screw microcompounder at 190° C. with screw speed of 100 rpm. The composition is mixed for 5 min to allow for efficient mixing and extruded thereafter in the form of strands which are pelletized manually. A disk of 1″ diameter is compression molded and is mounted in the rheometer (TA ARES-G2). Dynamic mechanical rheology is performed on this sample (1 rad/s at a strain amplitude of 1%) as the sample is cooled from the melt state (200° C.). The complex viscosity of the sample is recorded as a function of temperature. We observe that there is an increase in the complex viscosity at about 160° C., above the polyethylene crystallization temperature (FIG. 3). This increase is attributed to the formation of a reinforcing network of the Millad NX 8000 in the polyethylene melt.

With extrusion of the pelletized material, a filament with diameter 1.70 (±0.05 mm) is prepared at 190° C. through “Göttfert Capillary Rheometer” at a fixed speed which is optimised to provide a filament with a constant diameter of 1.75 mm (±0.05 mm). The filament obtained in the said manner is wound on a spool which may be connected to the 3D printer.

The filament is loaded in “Julia”, an FDM based 3D printer of Fractal Works, and printed with following print parameters:

1) Nozzle Diameter=0.4 mm

2) Nozzle Temperature=190° C.

3) Bed Temperature=60° C.

4) Bottom Layer Thickness=0.3 mm

5) Print Speed=45 mm/s

6) Fill Density=20%

7) Adhesion Assist: Thin layer of PVA based glue is applied on the bed for improved adhesion.

8) Adhesion Assist: Brim=15 Lines

9) Cooling Fan: Enabled at full after 0.5 mm

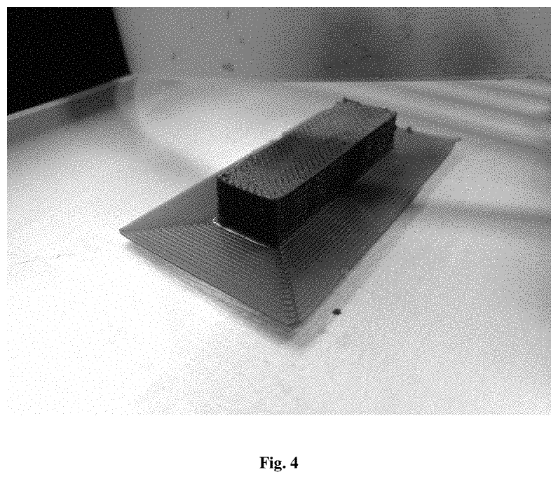

3D objects printed with the instant invention, demonstrated in FIG. 4, are warpage-free.

The warpage is calculated using following formula:

$$Warpage = 100 - \frac{Lay flat Height}{Thickness} \times 100$$

A higher value indicates higher warping. A long, solid bar, having dimensions of x=50 mm, y=15 mm, z=10 mm is selected as the standard test part for the calculations of warpings. In the case of our test part (the long solid bar, that is most prone to warpage), the features which warp the most are the corners of the bar. Therefore, warping is calculated at the corner and that value is assigned to the part. For this part, the warpage calculated is 0.

### Example 3

The polymer composition comprising PP (grade name: 4481WZ obtained from Total) present in amount of 99.2% and dimethyldibenzylidene sorbitol in amount of 0.8% was prepared. PP of the instant composition has MFI of 4, and with a DSC melting point of approximately 160° C. The composition was compounded in the DSM co-rotating twin screw microcompounder at 230° C. with screw speed of 100 rpm. The composition is mixed for 5 min to allow for efficient mixing and extruded thereafter in the form of strands which are pelletized manually.

With extrusion of the pelletized material, a filament with diameter 1.70 (±0.05) mm is prepared at 190° C. through “Göttfert Capillary Rheometer” at a fixed speed which is optimised to provide a filament with a constant diameter of 1.75 mm (+/− 0.05 mm). The filament obtained in the said manner is wound on a spool which may be connected to the 3D printer.

The filament is loaded in “Julia”, an FDM based 3D printer of Fractal Works, and printed with following print parameters:

1) Nozzle Diameter=0.4 mm

2) Nozzle Temperature=230° C.

3) Bed Temperature=60° C.

4) Bottom Layer Thickness=0.3 mm

5) Print Speed=40 mm/s

6) Fill Density=20%

7) Adhesion Assist: Thin layer of glue from a glue stick is applied on the bed for improved adhesion.

8) Adhesion Assist: Brim=15 Lines

9) Cooling Fan: Enabled at full after 0.5 mm

Warpage is calculated using following formula:

$$Warpage = 100 - \frac{Lay flat Height}{Thickness} \times 100$$

A higher value indicates higher warping. A long, solid bar, having dimensions of x=50 mm, y=15 mm, z=10 mm is selected as the standard test part for the calculations of warping. In the case of our test part (the long solid bar, that is most prone to warpage), the features which warp the most are the corners of the bar. Therefore, warping is calculated at the corner and that value is assigned to the part.

Warpage of standard test part printed with above composition:

| | 0.8% (DMDBS) + 99.2% PP (4481WZ) |
|---|---|
| Warpage Parameter | 0.8 |

### Example 4

The polymer composition comprising HDPE present in amount of 89.6%, calcium hexahydrophthalic acid (HPN 20E) in amount of 0.4% and LLDPE present in amount of 10% was prepared. HDPE of the instant composition has MFI of 1, and with a DSC melting point of approximately 140° C. The composition was compounded in the DSM co-rotating twin screw micro-compounder at 190° C. with screw speed of 100 rpm. The composition is mixed for 5 min to allow for efficient mixing and extruded thereafter in the form of strands which are pelletized manually.

With extrusion of the pelletized material, a filament with diameter 1.70 (±0.05) mm is prepared at 190° C. through “Göttfert Capillary Rheometer” at a fixed speed which is optimised to provide a filament with a constant diameter of 1.75 mm (+/−0.05 mm). The filament obtained in the said manner is wound on a spool which may be connected to the 3D printer.

The filament is loaded in “Julia”, an FDM based 3D printer of Fractal Works, and printed with following print parameters:

1) Nozzle Diameter=0.6 mm

2) Nozzle Temperature=230° C.

3) Bed Temperature=60° C.

4) Bottom Layer Thickness=0.3 mm

5) Print Speed=30 mm/s

6) Fill Density=20%

7) Adhesion Assist: Thin layer of glue from a glue stick is applied on the bed for improved adhesion.

8) Adhesion Assist: Brim=15 Lines

9) Cooling Fan: Enabled at full after 0.5 mm

The warpage is calculated using following formula:

$$Warpage = 100 - \frac{Lay flat Height}{Thickness} \times 100$$

A higher value indicates higher warping. A long, solid bar, having dimensions of x=50 mm, y=15 mm, z=10 mm is selected as the standard test part for the calculations of warping. In the case of our test part (the long solid bar, that is most prone to warpage), the features which warp the most are the corners of the bar. Therefore, warping is calculated at the corner and that value is assigned to the part.

Warpage of standard test part printed with different compositions:

| | Neat | 0.4% (HPN 20E) + 10% |
|---|---|---|
| | HDPE | LLDPE + 89.6% HDPE |
| Warpage Parameter | 9 | 7.2 |

This can be contrasted to the case of the composition containing 0.4% Millad 3988 (dimethyldibenzylidene sorbitol), 10% LLDPE and 89.6% HDPE. The warpage parameter during 3D printing of the standard test part was 0. In general, we define “low” warpage as systems where printing of the standard test part yields a warpage parameter less than 1.

### Advantages of the Invention

Warp-free 3D printing of semicrystalline polymer objects.

1. A composition for warpage-free 3D printing comprising a blend of:
i. 98 to 99.8 parts of a semi-crystalline polymer and;
ii. 0.2 to 2 parts of a nanofibrillar network forming additive.

2. The composition as claimed in claim 1, wherein the nanofibrillar network forming additive used is a sorbitol derivative, which dissolves into the semi-crystalline polymer above the melt temperature of the semi-crystalline polymer to form a nanofibrillar network.

3. The composition as claimed in claim 2, wherein the sorbitol derivative is selected from the group consisting of dimethyldibenzylidene sorbitol (DMDBS) and 1,2,3-tridesoxy-4,6:5,7-bis-O-[(4-propylphenyl)methylene]nonitol sorbitol (NX 8000).

4. The composition as claimed in claim 1, wherein the semi-crystalline polymer is selected from the group consisting of High-Density Polyethylene (HDPE), Medium-Density Polyethylene (MDPE), low density polyethylene (LDPE), linear low density polyethylene (LLDPE), Polyoxymethylene (POM), isotactic Polypropylene (PP), a copolymer of Polypropylene (CP-PP), and an impact copolymer of polypropylene (IC-PP), either alone or combination thereof.

5. A process for warpage-free 3D printing comprising:
preparing a blend of 98-99.8 parts of a semi-crystalline polymer and 0.2-2 parts of a nanofibrillar network forming additive;
compounding the blend as obtained in step (a) above the melting temperature of the semi-crystalline polymer to obtain a uniform composition;
extruding the composition as obtained in step (b) to obtain a constant diameter filament;
using the filament as obtained in step (c) for the warpage-free 3D printing.

6. A warpage-free 3D printing system comprising:
a blend of 98 to 99.8 parts of semi-crystalline polymer and 0.2-2.0 parts of a nanofibrillar network forming additive; and
a 3D printer.

7. The warpage-free 3D printing system as claimed in claim 6, wherein the semi-crystalline polymer used comprises a combination of 5-15 parts of linear low density polyethylene (LLDPE) in High-Density Polyethylene (HDPE).

8. The warpage-free 3D printing system as claimed in claim 6, wherein the semi-crystalline polymer used is selected from the group consisting of Medium-Density Polyethylene (MDPE), low density polyethylene (LDPE), linear low density polyethylene (LLDPE), Polyoxymethylene (POM), isotactic Polypropylene (PP), copolymer of Polypropylene (CP-PP), and impact copolymer of polypropylene (IC-PP) either alone or combination thereof.

9. The warpage-free 3D printing system as claimed in claim 6, wherein the nanofibrillar network forming additive is a sorbitol derivative, wherein said sorbitol derivative dissolves into said polymer above the melt temperature of said polymer to form a nanofibrillar network.

10. The warpage-free 3D printing system as claimed in claim 9, wherein said sorbitol derivative is selected from the group consisting of dimethyldibenzylidene sorbitol (DMDBS) and 1,2,3-tridesoxy-4,6:5,7-bis-O-[(4-propylphenyl)methylene]nonitol sorbitol (NX 8000).

11. (canceled)
